(19) United States
(12) Patent Application Publication
(10) Pub. No.: US 2015/0375815 A1
(43) Pub. Date: Dec. 31, 2015

(54) SYSTEM FOR REMOVING PIN OF A TRACK ASSEMBLY

(71) Applicant: Caterpillar Global Mining LLC, Oak Creek, WI (US)

(72) Inventors: Sivakumar Ramaiyan, Chennai (IN); Brett E. Burke, Washington, IL (US); Sivanesaselvam Thangarajan, Chennai (TN)

(73) Assignee: Caterpillar Global Mining LLC, Oak Creek, WI (US)

(21) Appl. No.: 14/852,628

(22) Filed: Sep. 14, 2015

(51) Int. Cl. B62D 55/32

(52) U.S. Cl. CPC B62D 55/32

(57) ABSTRACT

A system for removing a pin connecting adjacent tracks of a track assembly is disclosed. The system includes: a bracket member, a holder member, a guiding member, a stop member, a pusher member, a plurality of inserts, a top member, a spring member and a cylinder assembly. The cylinder assembly can be adapted to sequentially push one insert of the plurality of inserts disposed on the stop member through the actuation opening to move the pin with respect to the adjacent tracks.

### TECHNICAL FIELD

The present disclosure relates to a track assembly, and more particularly relates to a system for removing a pin of a track assembly.

### BACKGROUND

Machines, such as track type tractors, include a track assembly for engaging with a ground surface and for providing required traction between the machine and the ground surface. The track assembly includes tracks which are connected to each other via pins. After a prolonged operation of the machine, various components of the track assembly may wear out. In an example, the track and/or the pin may undergo wear due to relative motion between two adjacent tracks and contact with the ground surface. Hence, periodic maintenance and servicing of the track assembly is required to ensure durability of the track assembly. Generally, the pins are removed by drilling holes within the pins to pull the pins out of the track assembly. Such method of disassembling the track assembly consumes more time and thereby increase machine down time. Further, the removed pins become scrap material. Moreover, other components of the track assembly may also get damaged during such pin removal method.

U.S. Publication Number 2014/0167498 (the '498 publication) discloses a track for a tracked vehicle including two or more track shoes. The track shoes include one or more links having a first link end and a second link end, one or more pins received by one or more links and movable between an installed position and a dislodged position, and one or more pockets positioned adjacent to the pin and formed to receive a hydraulic jack. A first link end of a first track shoe is configured to pivotally couple with a second link end of a second track shoe, and a second link end of a first track shoe is configured to pivotally couple with a first link end of a third track shoe. The track may also include a pin removal system configured to dislodge the pin from the track. However, the pin removal system of the '498 publication discloses a hydraulic jack which needs to be positioned with respect to the pin with the help of a fixture to remove the pin. Hence, handling of the hydraulic jack to remove the pin becomes a complex process.

### SUMMARY OF THE DISCLOSURE

In one aspect of the present disclosure, a system for removing a pin connecting adjacent tracks of a track assembly is provided. The adjacent tracks define an opening therebetween. The system includes a bracket member received at least partially within the opening. The system further includes a holder member coupled to the bracket member. The holder member includes a projecting portion adapted to be received on a surface of one of the adjacent tracks to support the tool system within the opening. The system further includes a guiding member at least partly received within the opening and coupled to the bracket member. The guiding member defines a longitudinal axis therethrough. The guiding member further defines an actuation opening adjacent to an end thereof. The actuation opening is disposed adjacent to the pin of the track assembly. The system further includes a stop member coupled to the guiding member at the end thereof. The system further includes a pusher member spaced apart from the stop member and movable along the longitudinal axis relative to the guiding member. The system further includes a plurality of inserts received within the guiding member along the longitudinal axis. Each of the plurality of inserts contacting an adjacent insert of the plurality of inserts. The plurality of inserts is disposed between the pusher member and the stop member. One insert of the plurality of inserts disposed on the stop member is located adjacent to the pin. The system further includes a top member coupled to the pusher member. The top member is movable along the longitudinal axis with respect to the guiding member. The system further includes a spring member connected between the top member and the stop member. The spring member is adapted to bias the plurality of inserts towards the stop member. The system further includes a cylinder assembly coupled to the bracket member and the guiding member. The cylinder assembly is adapted to sequentially push the one insert of the plurality of inserts disposed on the stop member through the actuation opening to move the pin with respect to the adjacent tracks.

Other features and aspects of this disclosure will be apparent from the following description and the accompanying drawings.

### BRIEF DESCRIPTION OF THE DRAWINGS

FIG. 1 is a partial perspective view of a track assembly and a system for removing a pin associated with the track assembly, according to an embodiment of the present disclosure;

FIG. 2 is a perspective view of the system, according to an embodiment of the present disclosure;

FIG. 3 is a sectional view of the system taken along line C-C′ in FIG. 2, according to an embodiment of the present disclosure; and

FIG. 4 is a sectional view of the track assembly and the system taken along line B-B′ in FIG. 1, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

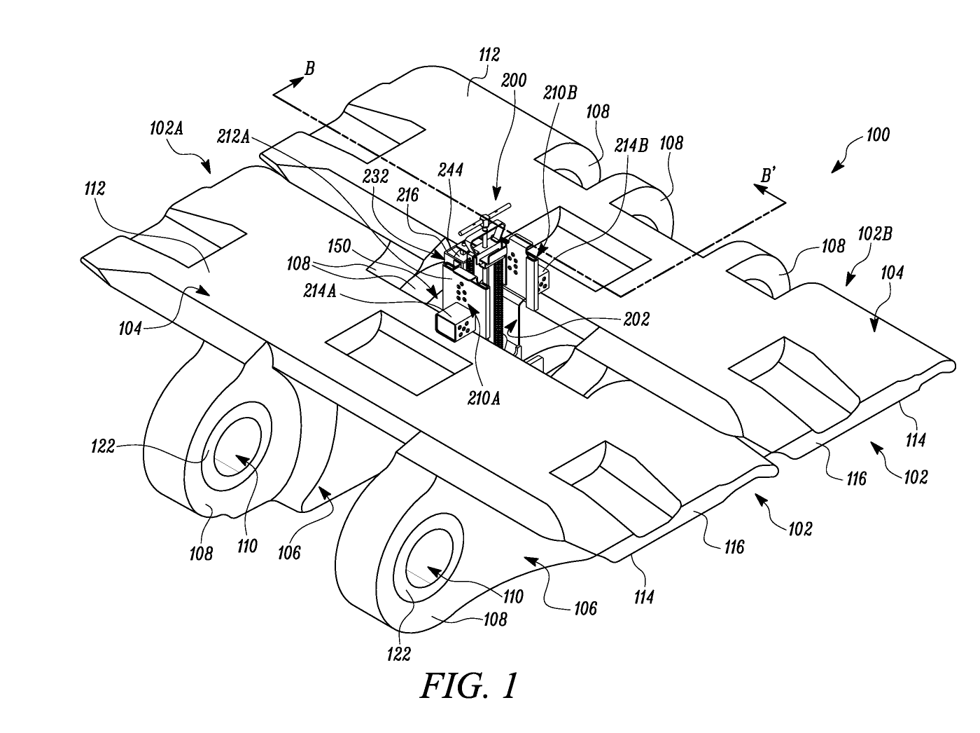

FIG. 1 illustrates a partial perspective view of a track assembly 100. The track assembly 100 can be used in various machines, such as excavators, track type tractors, bulldozers, tanks or any other machines which have tracked undercarriage systems as ground engaging members for moving the machine over a ground surface. The track assembly 100 includes multiple tracks 102 which are connected to each other to define the track assembly 100. The tracks 102 engage with the ground surface during movement of the machine to provide traction between the ground surface and the machine.

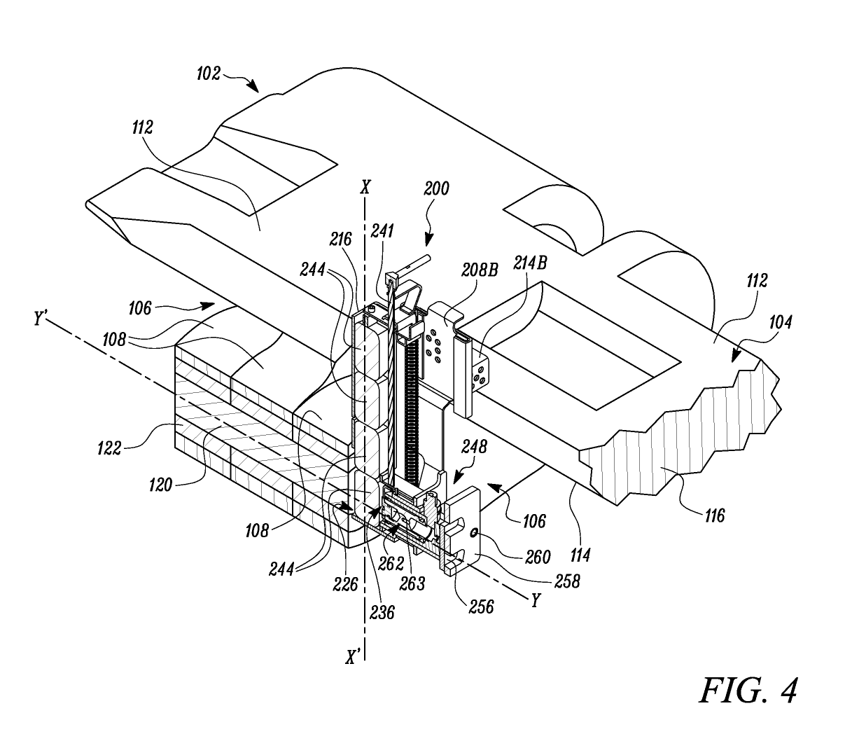

A portion of the track assembly 100 having a first track 102A and a second track 102B connected to the first track 102A are shown in FIG. 1 for illustration. Each of the first and second tracks 102A, 102B includes a pad portion 104 and a link portion 106 connected to the pad portion 104. The link portion 106 includes multiple connecting portions 108. The first track 102A and the second track 102B are positioned adjacent to each other such that the connecting portion 108 of the link portion 106 of the second track 102B contact with the connecting portion 108 of the link portion 106 of the first track 102A. Each of the connecting portions 108 includes a hole 110 for receiving a pin 120 (shown in FIG. 4) therethrough. The holes 110 of connecting portion 108 of the first track 102A and the holes 110 of the connecting portion 108 of the second track 102B are further aligned coaxially to receive the pin 120 therethrough. The connecting portion 108 of the link portion 106 of the first track 102A is further connected to a corresponding connecting portion 108 of the link portion 106 of the second track 102B via the pin 120 (shown in FIG. 4) to connect the first and second tracks 102A, 102B. A bushing 122 is disposed within each of the holes 110 to receive the pin 120 therethrough.

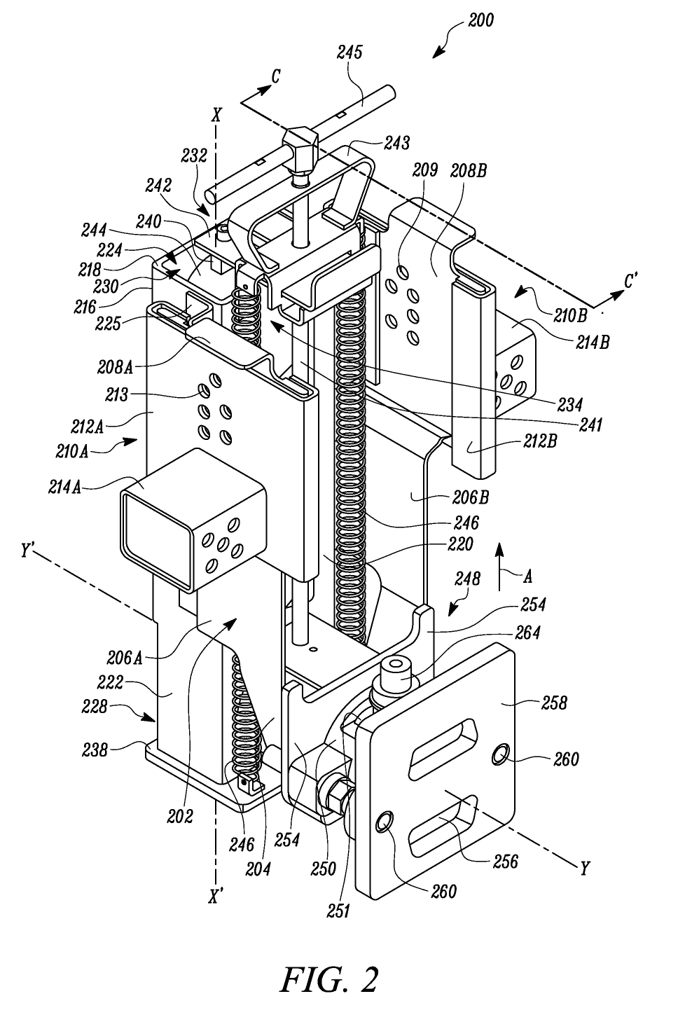

The pad portion 104 of the first and second tracks 102A, 102B contacts with the ground surface. The pad portions 104 can also include additional members, such as grouser bars (not shown), that can provide increased traction between the machine and the ground surface. The pad portion 104 further includes a body 116 having a top surface 112 and a bottom surface 114 distal to the top surface 112. The top surface 112 contacts with the ground surface during movement of the machine over the ground surface. The track assembly 100 includes an opening 150 defined between two adjacent tracks 102. As shown in FIG. 1, the opening 150 is defined between the first and second tracks 102A, 102B. A system 200, described in FIGS. 2 to 4 in detail, is inserted through the opening 150 to remove the pin 120 from the track assembly 100, according to an embodiment of the present disclosure.

FIG. 2 illustrates a perspective view of the system 200. As shown in FIG. 1, the system 200 is shown to be disposed within the opening 150 for removing the pin 120 (shown in FIG. 4) from the track assembly 100. The system 200 is positioned near to the pin 120 within the opening 150. The system 200 is used to move the pin 120 out of the holes 110 of the link portions 106 such that the first and second tracks 102A, 102B can be disengaged.

The system 200 includes a bracket member 202 having a base portion 204 and a first intermediate portion 206A and a second intermediate portion 206B connected to the base portion 204. The bracket member 202 also includes a first upper portions 208A and a second upper portion 208B connected to the first and second intermediate portions 206A, 206B, respectively. The base portion 204, the first and second intermediate portions 206A, 206B and the first and second upper portions 208A, 208B are connected to each other. Each of the first and second upper portions 208A, 208B includes six bracket holes 209. Although the first and second upper portions 208A, 208B are described to include six bracket holes 209, it may also be contemplated that the first and second upper portions 208A, 208B may include any number of bracket holes 209.

The system 200 further includes a first holder member 210A and a second holder member 210B. Each of the first and second holder members 210A, 210B is connected to the first and second upper portions 208A, 208B, respectively. The first and second holder members 210A, 210B includes a first holder base portion 212A and a second holder base portion 212B, respectively. The first and second holder base portions 212A, 212B of the first and second holder members 210A, 210B are engaged with the first and second upper portions 208A, 208B, respectively, such that the first and second holder members 210A, 210B can be moved towards the base portion 204 of the bracket member 202. Each of the first and second holder base portions 212A, 212B includes multiple holder holes 213. The holder holes 213 and the bracket holes 209 are aligned to each other to receive a pin member (not shown) to lock the first and second holder members 210A, 210B with the first and second upper portions 208A, 208B, respectively.

The first and second holder members 210A, 210B includes a first projecting portion 214A and a second projecting portion 214B, respectively. The first and second projecting portions 214A, 214B are attached to the first and second holder base portions 212A, 212B, respectively. As shown in FIG. 1, the first and second projecting portions 214A, 214B abut the top surface 112 of the pad portion 104 of the first and second tracks 102A, 102B to support the system 200 within the opening 150.

The system 200 further includes a guiding member 216 defining a longitudinal axis XX′ along a length thereof. The guiding member 216 is an elongate member having a first wall 218 and a second wall 220 spaced apart from each other. The guiding member 216 includes a pair of side walls 222 extending between the first wall 218 and the second wall 220 to define a cavity 224 within the guiding member 216. The side walls 222 are connected to the first and second upper portions 208A, 208B and the first and second intermediate portions 206A, 206B of the bracket member 202. The side walls 222 are connected to the first and second upper portions 208A, 208B, via a bracket plate 225, such that a clearance is defined between the first and second upper portions 208A, 208B and the side walls 222.

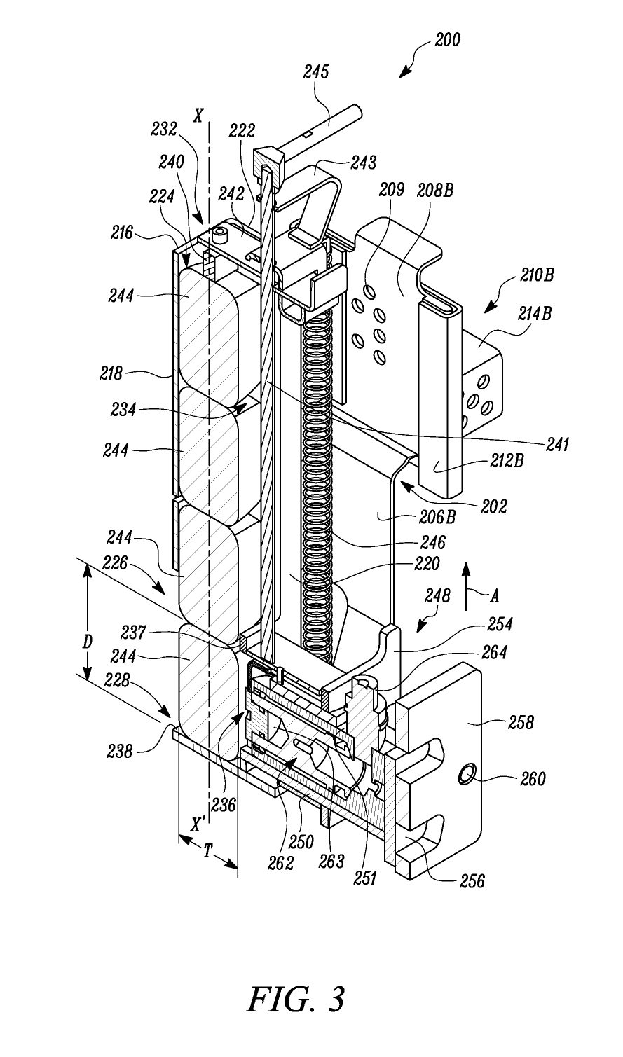

The first wall 218 of the guiding member 216 defines an actuation opening 226 (shown in FIG. 3) at a first end 228 of the guiding member 216. The guiding member 216 defines a first guide opening 230 at a second end 232 of the guiding member 216. As shown in FIG. 1, the guiding member 216 is at least partly received within the opening 150 between the first and second tracks 102A, 102B such that the second end 232 of the guiding member 216 extends above the top surface 112 of the first and second tracks 102A, 102B.

FIG. 3 illustrates a sectional view of the system 200 taken along a line C-C′ in the FIG. 2. The guiding member 216 includes a channel 234 defined in the second wall 220. The channel 234 extends from the second end 232 of the guiding member 216 along the longitudinal axis XX, towards the first end 228 of the guiding member 216. The second wall 220 of the guiding member 216 also defines a second guide opening 236 at the first end 228 of the guiding member 216. A stopper 237 is provided between the channel 234 and the second guide opening 236.

The system 200 further includes a stop member 238 connected to the guiding member 216 at the first end 228 thereof. The system 200 further includes a pusher member 240 positioned at the second end 232 of the guiding member 216. The system 200 further includes a top member 242 connected to the pusher member 240. The top member 242 and the pusher member 240 can be moved along the longitudinal axis XX′. The top member 242 is further attached to a handle 243. The channel 234 of the second wall 220 allows the handle 243 along with top member 242 to move downwards.

The pusher member 240 is further connected to a guide rod 241 such that the top member 242 can be moved within the channel 234 of the guiding member 216. A movement of the pusher member 240 along with the top member 242 is restricted by the stopper 237. Therefore, the pusher member 240 along with the top member 242 moves between the second end 232 of the guiding member 216 and the stopper 237

Referring to FIG. 3, the system 200 further includes multiple inserts 244. The inserts 244 are positioned within the cavity 224 of the guiding member 216 such that the inserts 244 are positioned along the longitudinal axis XX′. Each of the inserts 244 contacts with adjacent inserts 244 such that the multiple inserts 244 are stacked together within the cavity 224 of the guiding member 216. Each of the inserts 244 has a circular cross section defining a diameter ‘D’ and a thickness ‘T’. The diameter ‘D’ of each of the inserts 244 can be equal to or less than a diameter of a hole 110 of the connecting portions 108 such that the insert 244 can be received within the hole 110 to disengage the pin 120 from the track assembly 100. Further, a sum of the thicknesses ‘T’ of each of the inserts 244 can be less than or equal to a length 1′ of the pin 120. As shown in FIG. 4, the inserts 244 are positioned between the pusher member 240 and the stop member 238. One of the inserts 244 is positioned on the stop member 238 adjacent to the pin 120.

The system 200 includes a pair of spring members 246 positioned between the top member 242 and the stop member 238. The spring members 246 bias the inserts 244 towards the stop member 238. A tensioning member 245 is further provided on the guide rod 241 to increase or decrease a stiffness of the spring members 246. The tensioning member 245 can be rotated with respect to the guide rod 241 to allow the top member 242 to move with respect to the spring members 246. The system 200 further includes a cylinder assembly 248. The cylinder assembly 248 is assembled to the first end 228 of the bracket member 202. The cylinder assembly 248 is also supported on the base portion 204 of the guiding member 216. The cylinder assembly 248 includes a housing 250. The housing 250 is an elongate member. The housing 250 is connected to the second wall 220 of the guiding member 216 such that the housing 250 communicates with the cavity 224 of the guiding member 216. The housing 250 also defines a actuator connecting opening 251 which is spaced apart from the actuation opening 226 along a transverse axis YY′ perpendicular to the longitudinal axis XX′.

Referring to FIGS. 1 to 4, the cylinder assembly 248 further includes a mounting plate 254 connected to the housing 250 and the base portion 204 of the bracket member 202. The cylinder assembly 248 also includes a back plate 256 (shown in FIG. 3) connected to an end of the housing 250. A reinforcement plate 258 is also connected to the back plate 256 and the housing 250. The reinforcement plate 258, the back plate 256 and the mounting plate 254 are connected to each other via a pair of fasteners 260, such as bolts and nuts.

The cylinder assembly 248 includes an actuating member 262 positioned within the housing 250. Specifically, the actuating member 262 is encapsulated by the housing 250. As shown in FIG. 3, the actuating member 262 is a pneumatic cylinder. The actuating member 262 includes a piston 263. The piston 263 can be moved along the transverse axis YY′ based on a user input. The actuating member 262 is connected to a power source (not shown), for example, an air compressor tank, via an actuator connecting portion 264, to receive compressed air. The compressed air moves the piston 263 towards the actuation opening 226 along the transverse axis YY′. A stroke of the piston 263 of the actuating member 262 may be determined based on a thickness of each of the inserts 244. For example, the stroke of the piston 263 can be equal to the thickness ‘T’ of each of the inserts 244 such that in one stroke of the piston 263, the actuating member 262 pushes one insert within the holes 110 of a corresponding connecting portion of the tracks 102.

Further, the actuator connecting portion 264 extends through the actuator connecting opening 251 along a direction ‘A’. The actuator connecting portion 264 can be connected to a conduit (now shown) to receive the flow of pressurized air. Though the pressurized air is disclosed, it may be contemplated that the actuating member 262 may receive any other fluid. Further, the actuator connecting portion 264 can include one or more valves (not shown) to control a flow of the pressurized air therethrough.

Upon receiving the pressurized air, the actuating member 262 pushes the one of the inserts 244 positioned on the stop member 238 through the actuation opening 226 to move the pin 120 relative to the first and second tracks 102A, 102B. The pin 120 is moved along the transverse axis YY′ by a distance equal to the thickness ‘T’ of one of the inserts 244. The piston 263 further moves within the housing 250 to allow an intermediate insert 244 positioned adjacent to the stop 234 to move towards the stop member 238. The pusher member 240 pushes the consecutive inserts towards the stop member 238 along the longitudinal axis XX′ such that the insert positioned adjacent to the stopper 237 contacts the stop member 238. Similarly, consecutive inserts positioned within the guiding member 216 are pushed into the holes 110 of the connecting portion of the link portions 106 to push the pin 120 out of the holes 110 of connecting portions 108.

Industrial Applicability

The present disclosure relates to the system 200 for removing the pin 120 connecting the adjacent tracks 102 of the track assembly 100. The system 200 is positioned within the opening 150 defined by the first and second tracks 102A, 102B of the track assembly 100. The first and second holder members 210A, 210B of the system 200 are supported on the top surfaces 112 of each of two adjacent tracks 102 to support the system 200 within the opening 150. Since, the first and the second holder members 210A, 210B can be moved with respect to the bracket member 202, it provides flexibility for the system 200 to be used for disassembling the track assembly of various machines. Further, the system 200 includes the cylinder assembly 248 that pushes each of the inserts 244 into the holes 110 of the connecting portions 108 of the link portions 106 of the tracks 102. The inserts 244 can also be inserted again within the guiding member 216 by pulling the top member 242 away from the second end 232. Thereby, the first and the second tracks 102 of the track assembly 100 can be disengaged by removing the other pins with respect to the tracks 102. Since, an operation of the actuating member 262 can be automated, time and effort required for disengaging the adjacent tracks 102 of the track assembly 100 can be reduced. Therefore, the system 200 may help reduce downtime and maintenance costs by reducing time required to replace or repair a track of the track assembly 100. Moreover, since the system 200 uses the inserts 244 to push the pin 120 out of the track assembly 100, the pin 120 may be reused after repair.

While aspects of the present disclosure have been particularly shown and described with reference to the embodiments above, it will be understood by those skilled in the art that various additional embodiments could be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A system for removing a pin connecting adjacent tracks of a track assembly, the adjacent tracks defining an opening therebetween, the system comprising:
a bracket member received at least partially within the opening;
a holder member coupled to the bracket member, the holder member comprising a projecting portion adapted to be received on a surface of one of the adjacent tracks to support the system within the opening;
a guiding member at least partly received within the opening and coupled to the bracket member, the guiding member defining a longitudinal axis therethrough, the guiding member further defining an actuation opening adjacent to an end thereof, wherein the actuation opening is disposed adjacent to the pin of the track assembly;
a stop member coupled to the guiding member at the end thereof;
a pusher member spaced apart from the stop member and movable along the longitudinal axis relative to the guiding member;
a plurality of inserts received within the guiding member along the longitudinal axis, each of the plurality of inserts contacting an adjacent insert of the plurality of inserts, wherein the plurality of inserts are disposed between the pusher member and the stop member, and wherein one insert of the plurality of inserts disposed on the stop member is located adjacent to the pin;
a top member coupled to the pusher member, the top member being movable along the longitudinal axis with respect to the guiding member;
a spring member connected between the top member and the stop member, the spring member adapted to bias the plurality of inserts towards the stop member; and
a cylinder assembly coupled to the bracket member and the guiding member, the cylinder assembly being adapted to sequentially push the one insert of the plurality of inserts disposed on the stop member through the actuation opening to move the pin with respect to the adjacent tracks.
